(19) United States
(12) Patent Application Publication
(10) Pub. No.: US 2014/0122074 A1
(43) Pub. Date: May 1, 2014

(54) METHOD AND SYSTEM OF USER-BASED JAMMING OF MEDIA CONTENT BY AGE CATEGORY

(71) Applicants: Amit V. Karmarkar, Palo Alto, CA (US); Richard Ross Peters, Mill Valley, CA (US)

(72) Inventors: Amit V. Karmarkar, Palo Alto, CA (US); Richard Ross Peters, Mill Valley, CA (US)

(21) Appl. No.: 13/662,814

(22) Filed: Oct. 29, 2012

(51) Int. Cl. G10K 11/00

(52) U.S. Cl. CPC G10K 11/002
USPC 704/246; 381/71.1

(57) ABSTRACT

In one exemplary embodiment, a computer-implemented method includes the step of determining an age group of a first user. Media content available to the first user is identified. It is determined whether the user has permission to listen to the media content. The media content is jammed with a sound wave at a frequency that can be heard by the user when the user does not have permission to listen to the media content. Optionally, a voice age-recognition algorithm to determine the age group of the first user. An age-group of a second user can be determined. The first user and the second user may be proximate to a media player providing the ambient sound stream.

### CROSS-REFERENCE TO RELATED APPLICATIONS

This application is a continuation-in-part of and claims priority to U.S. patent application Ser. No. 13/423,128 titled METHOD AND SYSTEM OF JAMMING SPECIFIED MEDIA CONTENT BY AGE CATEGORY and filed on Mar. 16, 2012. U.S. patent application Ser. No. 13/423,128 claims priority from U.S. Provisional Application No. 61/553,912, filed Oct. 31, 2011 and U.S. Provisional Application No. 61/569,272, filed Dec. 11, 2011. U.S. patent application Ser. No. 13/423,128 is hereby incorporated by reference in its entirety. The present application claims priority from U.S. Provisional Application No. 61/553,912, filed Oct. 31, 2011 and U.S. Provisional Application No. 61/569,272, filed Dec. 11, 2011. These provisional applications are hereby incorporated by reference in their entirety.

### BACKGROUND

1. Field

This application relates generally to digital media players, and more specifically to a system and method for user-based jamming specified media content by age category.

2. Related Art

It is known that a person's ability to hear high-frequency sound decreases with age. For example, persons under eighteen (18) years of age can typically hear eighteen (18) kHz sounds that most adults older than thirty (30) cannot hear. The following frequency audibility table demonstrates various high-frequency sound thresholds for various age groups. (It is noted that other frequency audibility tables can also be utilized according to various studies of age-related frequency hearing loss).

| Frequency | Age Group |
|---|---|
| 8 kHz | Everyone |
| 10 kHz | 60 & Younger |
| 12 kHz | 50 & Younger |
| 14.1 kHz | 49 & Younger |
| 14.9 kHz | 39 & Younger |
| 15.8 kHz | 30 & Younger |
| 16.7 kHz | 24 & Younger |
| 20 kHz | 18 & Younger |

Furthermore, the digital distribution of digital entertainment content has increased significantly. Various types of entertainment content such as digital television and movie services, user-uploaded videos and digital music are now widely and easily accessible. For example, various web sites now provide television shows, uploaded user videos and streaming movies that can be accessed through such ubiquitous devices as smart phones and tablet computers. At the same time, digital media receivers provide users with the ability to obtain digital entertainment content play it on a home theater system, television (e.g. a ‘smart TV’) or a portable media player. Accordingly, the demarcating lines between more traditional mediums of providing entertainment content and computing devices that can access the Internet have become increasingly blurred.

In this context, controlling access of young persons to digital entertainment content has become increasing important and difficult. For example, traditional forms of controlling Internet access (e.g. parental controls, workplace controls, etc.) often rely on blocking entire web sites or types of digital entertainment content. Controlling access to digital entertainment is often based on age-related concerns. For example, a parent may use a website blocking method to prevent children from accessing certain websites or watching certain television shows. Blocking methods can be inconvenient. The parent may need to deblock a web page or television channel in order to access it, and then reblock it afterwards. Such constant inconveniences can discourage use of parental controls. Thus, a system and method of jamming prohibited media content for pre-specified users according age categories is needed.

### BRIEF SUMMARY OF THE INVENTION

In one exemplary embodiment, a computer-implemented method includes the step of determining an age group of a first user. Media content available to the first user is identified. It is determined whether the first user has permission to listen to the media content. The media content is jammed with a sound wave at a frequency that can be heard by the first user when the first user does not have permission to listen to the media content.

Optionally, a voice age-recognition algorithm can determine the age group of the first user. An age-group of a second user can be determined. The first user and the second user may be proximate to a media player.

In another exemplary embodiment, an auditory jamming system configured to jam audio content is provided. The auditory jamming system includes an audio input device configured to receive ambient sounds. The auditory jamming system includes a user analysis system configured to determine an age group of a first user. The user analysis system identifies a media content available to the user. The user analysis system determines whether the user has permission to listen to the media content. The auditory jamming system includes an audio output management system configured to jam the media content with a sound wave at a frequency that can be heard by the user when the user does not have permission to listen to the media content.

### BRIEF DESCRIPTION OF THE DRAWINGS

The present application can be best understood by reference to the following description taken in conjunction with the accompanying figures, in which like parts may be referred to by like numerals.

FIG. 1 depicts, in block diagram format, an example process of user-based jamming of media content by age category, according to some embodiments.

FIG. 2 depicts an example application for user-based jamming of media content by age category, according to some embodiments.

FIG. 3 illustrates, in a schematic manner, an implementation of obtaining user voice streams in a particular location, according to some embodiments.

FIG. 4 illustrates, in a schematic manner, an implementation of jamming users of a specified age group in a particular location, according to some embodiments.

FIG. 5 depicts an example of a twenty (20) kHz sound wave used to jam an eighteen (18) and younger age group, according to some embodiments.

FIG. 6 depicts, in a schematic manner, an implementation of jamming specified media content by age category, according to some embodiments.

FIG. 7 depicts a computing system with a number of components that can be used to perform any of the processes described herein.

The Figures described above are a representative set of sample screens, and are not an exhaustive set of screens embodying the invention.

### DETAILED DESCRIPTION

Disclosed are a system, method, and article of manufacture of user-based jamming specified media content by age category. Although the present embodiments included have been described with reference to specific example embodiments, it can be evident that various modifications and changes may be made to these embodiments without departing from the broader spirit and scope of the particular example embodiment.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Exemplary Process

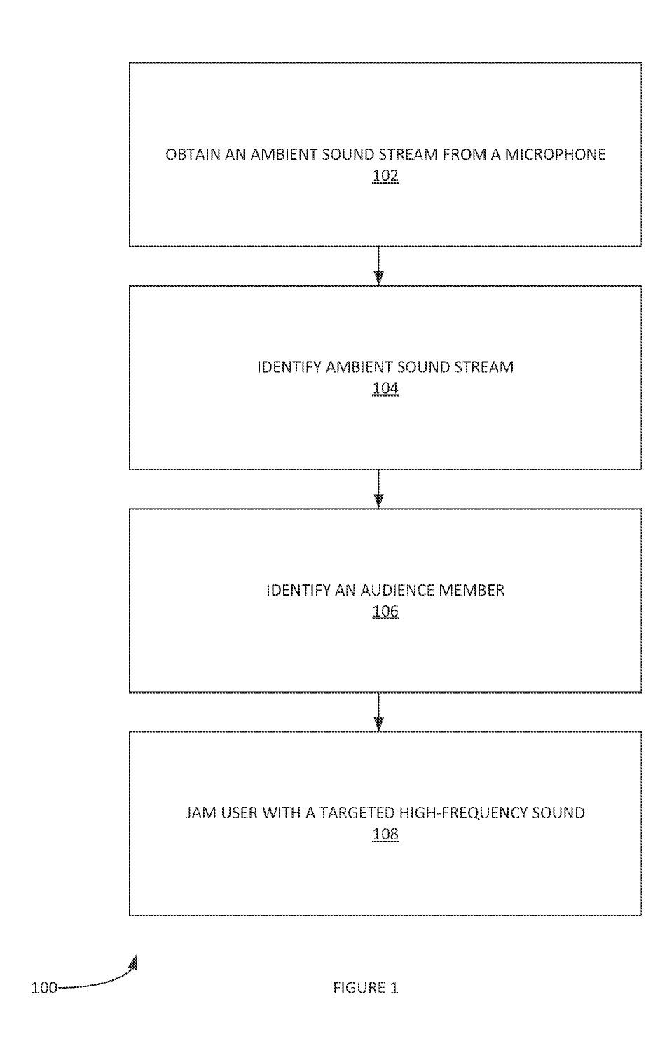

FIG. 1 depicts, in block diagram format, an example process 100 of user-based jamming of media content by age category, according to some embodiments. In step 102 of process 100, an ambient sound stream can be obtained from a microphone system. The microphone system can include one or more microphones that can monitor audio information in a specified location (e.g. a room, movie theater, vehicle, area of a school, a zone around an identified media device, and the like). The audio information can include audio streams from various sources such as human voices, played media content, etc. It is noted that in various embodiments, a media content can include any image, audio and/or video file format (e.g. mp3, mp4, way, ogg, jpeg, MPEG-4, AVC, SWF and the like).

In step 104, the elements of the ambient sound stream are identified. Various audio identification algorithms can be utilized to identify sound stream elements such as voice-recognition algorithms, sound-recognition algorithms, media content recognition algorithms, etc.

In step 106, the human user voice stream elements identified in step 104 are further analyzed to determine various attributes of the user such as the user's identity and/or age. For example, algorithms that analyze an audio file to determine a speaker's age can be implemented. In another example, the content of the user's speech can be analyzed for age-related cues (e.g. argot that indicates a user's age, user's vocabulary level, and/or topics user discusses that may indicate the user's age group).

It is noted that process 100 can include additional steps for determining an age of a user in lieu of and/or in addition to step 106. For example, video cameras can provide video input that includes images of a user. These images can be analyzed with facial recognition algorithms, algorithms that determine an age of a user based on physical appearance as well as other cues (e.g. behavior patterns, clothing types, and/or other age indicators), algorithms that analyze the user's biosignals (e.g. determines pulse, respiratory rate and/or blood pressure), and the like.

In yet another example, touch-based methods of determining a user's age can be utilized when a user is interacting with a touched-based input device (e.g. a tablet computer and/or a smart phone with a touchscreen). For example, a user's contact-patch attributes can be measured and a user's age estimated therefrom. In another example, a median ridge breadth (MRB) of a user's finger print can be measured by a touch screen system. The user's age can then be measured from a comparison of the user's contact-patch attributes (e.g. MRB attributes) with anthropological averages.

In still yet another example, a user's age can be determined based on a user's identity as determined by a user's mobile device signal. For example, a user's mobile device (e.g. a smart phone, tablet computer, gaming device and the like) can include an application that provides a signal identifying a user's age. In some embodiments, age can be approximated (e.g. speaker is less than twelve years old, high-probability that speaker is greater than sixty years old) based on combining results of one or more age-determining methodologies.

Various third-party databases can be queried in the case of when a user's identity is identified. For example, various social networks can be queried and/or reviewed with a spider program to obtain the user's age information. It is noted that step 104 and/or any of its subprocesses can be repeated on a periodic based such that the identity and/or age of any (as well as played media content) user in the identified location is known and substantially current.

In step 108, a user is jammed with a high-frequency sound. The high-frequency sound can be selected according to the user's age group. The high-frequency sound can also be selected such that it can be heard by a younger user (e.g. a child user) and not an older user (e.g. a middle-aged user). The high-frequency sound can be played substantially simultaneously with other media content audio files.

In one example, step 108 can be implemented if it is determined that available media content includes content that is prohibited to a specified age group (e.g. younger than eighteen years old). For example, an R-rated movie may be played in a living room. The sound streams in the living can be acquired by a sound-analysis system. The sound-analysis system can recognize the R-rated movie. A ten year old child may be detected in the living through voice analysis that identifies the child's voice and/or determines the child's age group (e.g. younger than eighteen years old). A forty year old adult may also be detected in the living as well. The media system can utilize process 100 to play a high-frequency sound pattern that can be heard by the ten year child and not the forty year old adult (e.g. utilizing the table provided supra). The volume and other attributes of the high-frequency sound pattern can be selected and modulated to elicit a desired response in the child listener. For example, the amplitude of the high-frequency sound pattern can be set to annoy the child and/or to prevent the child from hearing the other audio components of the movie. Other embodiments are not limited by this example.

### Exemplary System

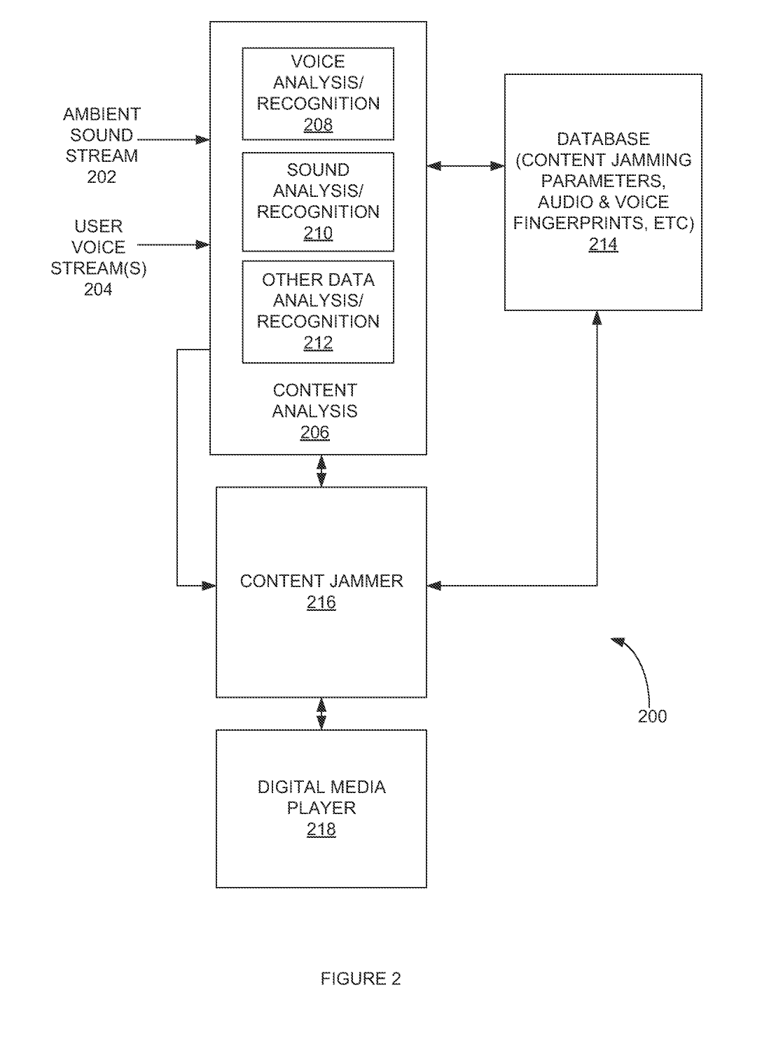

FIG. 2 depicts an example application 200 for user-based jamming of media content by age category, according to some embodiments. In some embodiments, application 200 can reside in a computing device that provides/plays media content. Example computing devices include tablet computers, smart phones, portable media players, smart televisions, digital media receivers (e.g. an apple television), Internet televisions, and the like. Ambient sound stream(s) 202 and/or user voice stream(s) 204 can be obtained by a content analysis engine 216 (e.g. via a microphone system). Content analysis engine 216 can parse incoming audio streams and identify various attributes of the stream. For example, content analysis engine 216 can identify a source of an audio stream, a type of sound included in the audio stream, an age of a speaker, etc. An audio stream (e.g. ambient sound stream 202 and/or user voice stream 204) can be any environmental sound obtained by a microphone system.

In one example, content analysis engine 216 can include a voice analysis/recognition module 208 (hereafter voice analysis module 204). Voice analysis module 208 can parse and identify various human voice attributes including, inter alia, a speaker's identity (e.g. with a voice identification algorithm), a speaker's age group, a speech content (e.g. with voice-to-text algorithms), and/or a speaker's emotional state. Voice analysis module 208 can detect argot that indicates a higher probability that a speaker is in a certain age group. Voice analysis module 208 can further analyze speech content to determine speaker attributes such as probable education level and thus infer an age group thereby. In some embodiments, voice analysis module 208 can provide audio files of voice recordings to third-party servers of voice recognition and/or age determination services in order to identify a user by voice and/or a user's age group.

Sound analysis/recognition module 210 (hereafter sound analysis engine 210) can parse and identify various ambient sound attributes including, inter alia, an ambient sound's identity (e.g. identify a media content such as a song, television show, movie, YouTube® video, etc.), an ambient sound's origin, and the like. For example, an audio file of the ambient sound can be identified using on an audio fingerprint based on a time-frequency graph (e.g. a spectrogram). A catalog of audio fingerprints can be maintained in a database (such as database 214). In one example, sound analysis engine 210 can tag a time period of an ambient sound (e.g. 10 seconds) and then create an audio fingerprint based on some of the anchors of the simplified spectrogram and/or the target area between them. For each point of the target area, sound analysis engine 210 can create a hash value that is the combination of the frequency at which the anchor point is located, the frequency at which the point in the target zone is located, and/or the time difference between the point in the target zone and when the anchor point is located in the ambient sound. Once the fingerprint of the audio is created, sound analysis engine 210 can then search for matches in the database 214. The ambient sound information is returned to the sound analysis engine 210 if there is a match. In some embodiments, sound analysis engine 210 can provide audio files of ambient sounds to third-party servers (e.g. a music identification service such as Shazam®, a movie/television show identification service and the like) in order to identify ambient sounds.

It is noted that content analysis engine 216 can utilize other methodologies to identify users and/or user age groups. For example, a computing device can include an image sensor. Application 200 can obtain images of users in the physical proximity of the computing device. In another example, computing device can include a touch screen capable of measuring user contact patch attributes. Additionally, a computing system that includes application 200 can include and/or communicate with various biosensors and/or biosignal measurement systems. The computing system can also include motion detector systems to determine when users are proximate to a monitored location. Various biosignal acquisition techniques can be utilized to measure a biosignal of a person. For example, a user's blinking rate can be acquired. A user's eye-tracking data vis-à-vis a set of objects can be acquired. A user's pulse rate and/or respiratory rate can be acquired with non-contact measurement methods (e.g. remote passive thermal imaging, tracking changes in light reflected from a user's skin, pulse-rate registration from face image portion of user, etc.). A user's thermal image can be obtained. In one example, a user can wear various computerized biosignal sensors. Thus, content analysis engine 216 can include other data analysis/recognition modules 214 that parse and analyze various other data streams with information about a user that can utilized to determine a user's identity and/or user age group.

Content jammer 208 can be set to manage the production of jamming sounds in the location. For example, a computing device can include a digital media player 218 with a speaker system. Content jammer 208 can cause the speaker system to play various high-frequency sound wave forms that can be heard by a younger age group and not an older age group. Content jammer 208 can be set to jam a location according to parameters received from database 214 and information about proximate users received from content analysis engine 216. In some examples, content jammer 208 can perpetually include various types of jamming sounds in media content. For example, if a television show includes a certain profanity term than each instance of the television can be jammed until it is reset by an application administrator (e.g. a parent, teacher, work supervisor, and the like). It is noted that the application administrator can set various jamming parameters and instructions that be stored in database 214. In one example, an administrator (and/or someone determined to be in an adult age group) can interface with application 200 via voice inputs. In this way, the administrator can speak commands (e.g. as interpreted by a speech recognition analysis) to ‘turn off jamming’. ‘turn on jamming for persons under eighteen years of age’, ‘change jamming frequency to eighteen kilo hertz’, and the like. The administrator can be identified by the application 200 with speaker recognition analysis systems.

### Example Use Cases

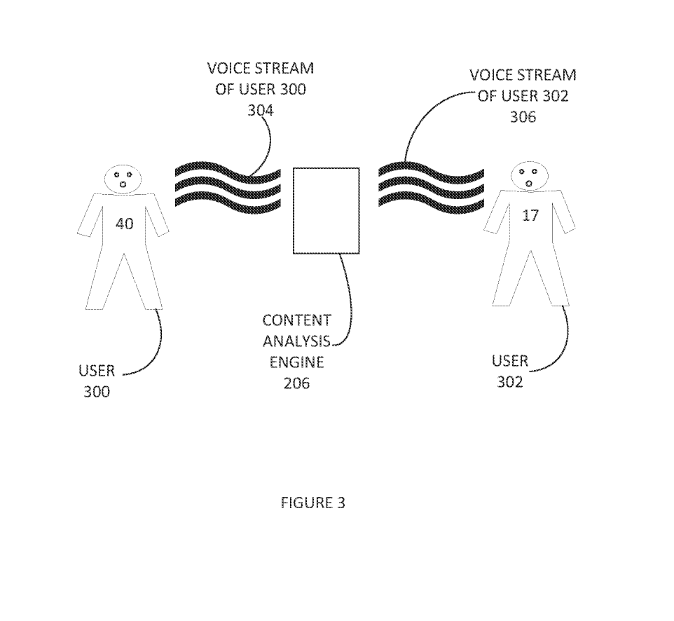

FIG. 3 illustrates, in a schematic manner, an implementation of obtaining user voice streams in a particular location, according to some embodiments. User 300 and/or user 302 can be located proximate to a computing device that includes application 200. Application 200 can include content analysis module 206. User 300 and/or 302 can speak (e.g. asynchronously or synchronously). User 300's speech can be obtained as a voice stream 304. User 302's speech can be obtained as voice stream 306. Content analysis module 206 can analyze voice streams 304 and 306 in order to determine attributes of users 300 and 302. For example, an age group of each user can be determined. In another example, a user's identity can be ascertained by analyzing voice streams 304 and 306.

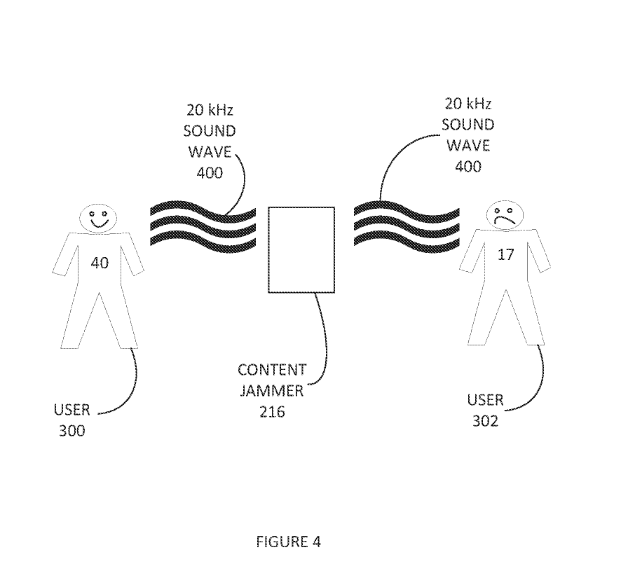

FIG. 4 illustrates, in a schematic manner, an implementation of jamming users of a specified age group in a particular location, according to some embodiments. User 300 and/or user 302 can be located proximate to a computing device that includes application 200. Application 200 can include content jammer 216. Application 200 can have determined that user 300 is approximately forty (40) years of age (e.g. based on information obtained from voice stream 304 as depicted in FIG. 3). Application 200 can have determined that user 302 is approximately seventeen (17) years of age (e.g. based on information obtained from voice stream 306 as depicted in FIG. 3). Content jammer 216 can cause an audio system of the computing device to play twenty (20) kHz sound wave 400 in order to jam user 302 from the location. Content jammer 216 can cause the audio system to play the twenty (20) kHz sound wave 400 either alone and/or substantially simultaneously with other media content (e.g. media content that is tagged with metadata that indicates that it is not appropriate for persons less than eighteen (18) years of age).

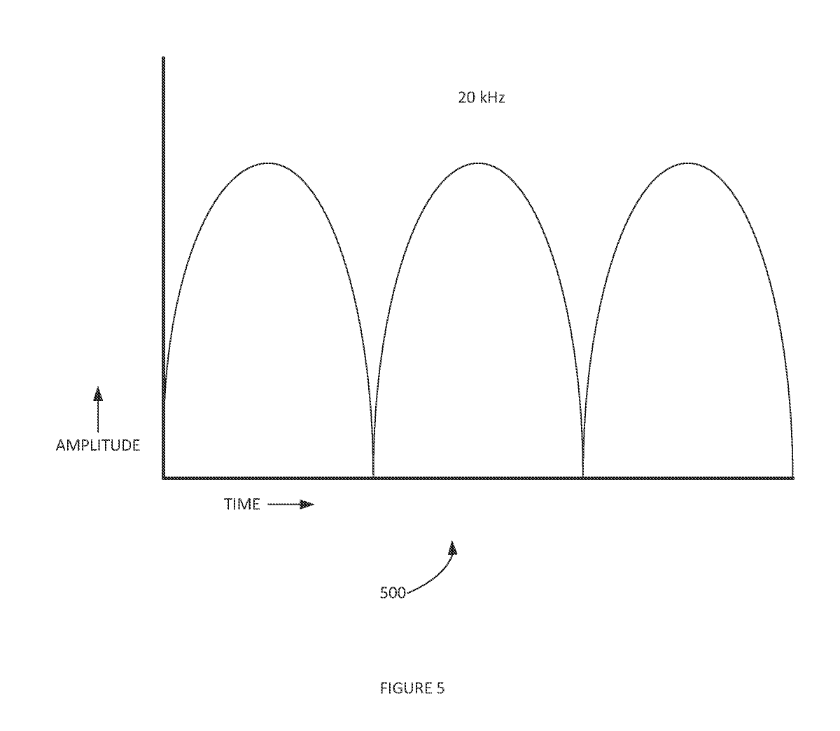

FIG. 5 depicts an example of a twenty (20) kHz sound wave 500 used to jam an eighteen (18) and younger age group. Sound wave 500 can be modulated according to various wave forms. As depicted, the amplitude of sound wave 500 can be modulated as a function of time. Other embodiments are not limited by this example. For example, a sound wave can have a constant amplitude. In another example, the amplitude of the sound wave can be increased substantially simultaneously with specified prohibited media content (e.g. profane terms, movie scenes with audio content that indicates certain violent acts, and the like).

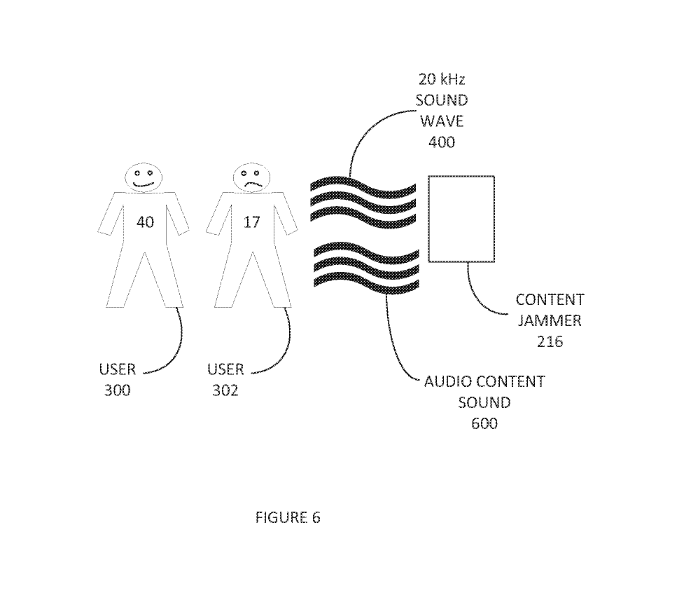

FIG. 6 depicts, in a schematic manner, an implementation of jamming specified media content by age category, according to some embodiments. User 300 and user 302 can be in the physical proximity of content jammer 216. User 300 can be forty (40) years of age and user 302 can be seventeen (17) years of age. Content jammer 216 can be included in a computing device that plays audio content sound 600 (e.g. a song obtained from a digital file, an audio track of a digital video and the like). Additionally, content jammer 216 can detect that the audio content file used for audio content sound includes and/or is associated with an attribute (e.g. descriptive metadata term, prohibited movie, flagged lyrics, unlicensed source and the like) that is tagged to initiate a jamming operation. The jamming operation also includes a targeted age group, which, in the present example, is eighteen (18) and younger. Thus, content jammer 216 can cause the computing device to play a high-frequency (e.g. in relation to the average human auditory range) sound such as twenty (20) kHz sound wave 400. The sound wave 400 may not be audible by user 300 but may be audible by user 302. Thus, user 300 can listen to audio content sound 600 without disturbance by sound wave 400. At the same time, user 302 can hear both sound wave 400 and audio content sound 600. In this way, sound wave 400 can obstruct user 302's ability to listen to audio content sound 600 without disturbance. In one example, sound wave 400 can be played at a volume sufficient for blocking out audio content sound 600 (e.g. at a higher volume). In another example, the volume of sound wave 400 can be modulated in order to annoy user 302 (e.g. as depicted in FIG. 5). Sound wave 400 can be turned off if audio content sound 600 is no longer played by the computing device, or for other reasons such as a license is obtained to play audio content sound 600, etc.

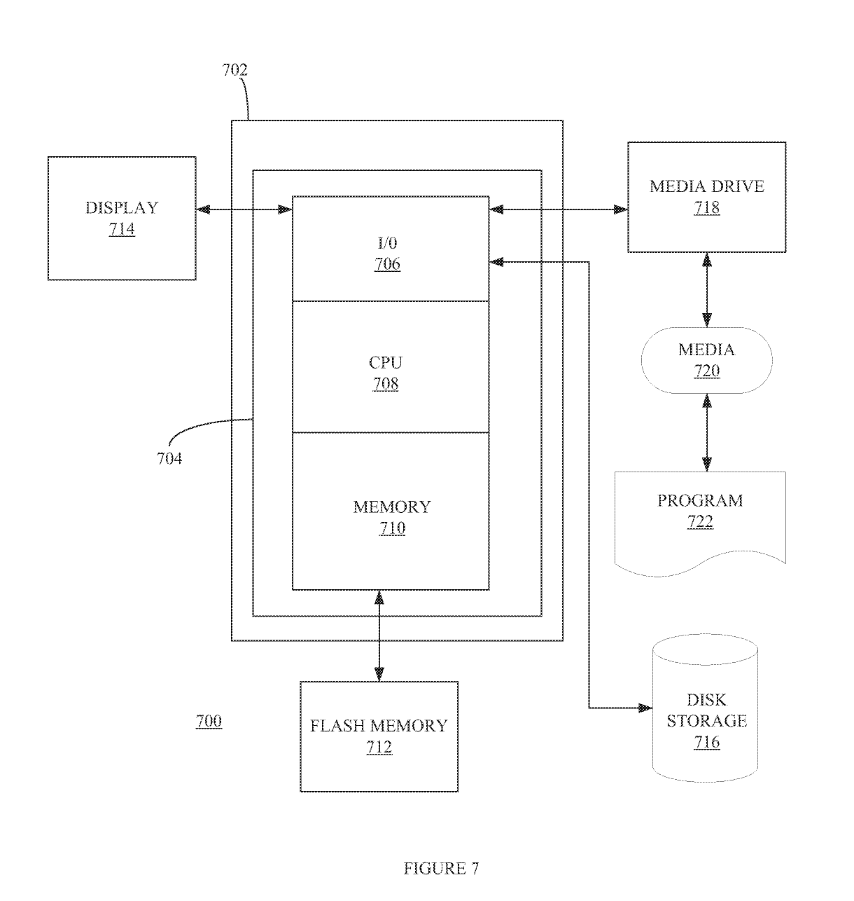

FIG. 7 depicts an exemplary computing system 700 that can be configured to perform several of the processes provided herein. In this context, computing system 700 can include, for example, a processor, memory, storage, and I/O devices (e.g., monitor, keyboard, disk drive, Internet connection, etc.). However, computing system 700 can include circuitry or other specialized hardware for carrying out some or all aspects of the processes. In some operational settings, computing system 700 can be configured as a system that includes one or more units, each of which is configured to carry out some aspects of the processes either in software, hardware, or some combination thereof.

FIG. 7 depicts a computing system 700 with a number of components that can be used to perform any of the processes described herein. The main system 702 includes a motherboard 704 having an I/O section 706, one or more central processing units (CPU) 708, and a memory section 710, which can have a flash memory card 712 related to it. The I/O section 706 can be connected to a display 714, a keyboard and/or other attendee input (not shown), a disk storage unit 716, and a media drive unit 718. The media drive unit 718 can read/write a computer-readable medium 720, which can include programs 722 and/or data. Computing system 700 can include a web browser. Moreover, it is noted that computing system 700 can be configured to include additional systems in order to fulfill various functionalities. Display 714 can include a touch-screen system and/or sensors for obtaining contact-patch attributes from a touch event. In some embodiments, system 700 can be included and/or be utilized by the various systems and/or methods described herein.

At least some values based on the results of the above-described processes can be saved for subsequent use. Additionally, a (e.g. non-transients) computer-readable medium can be used to store (e.g., tangibly embody) one or more computer programs for performing any one of the above-described processes by means of a computer. The computer program may be written, for example, in a general-purpose programming language (e.g., Pascal, C, C++, Java, Python) and/or some specialized application-specific language (PHP, Java Script, XML).

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium. Finally, acts in accordance with FIGS. 1-7 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

What is claimed as new and desired to be protected by Letters Patent of the United States is:

1. A computer-implemented method comprising:
determining an age group of a first user;
identifying a media content available to the first user;
determining whether the first user has permission to listen to the media content; and
jamming the media content with a sound wave at a frequency that can be heard by the first user when the first user does not have permission to listen to the media content.

2. The computer-implemented method of claim 1 further comprising:
implementing a voice age-recognition algorithm to determine the age group of the first user.

3. The computer-implemented method of claim 1 further comprising:
obtaining an image of the first user.

4. The computer-implemented method of claim 3 further comprising:
implementing an image age-recognition algorithm to determine the age group of the first user.

5. The computer-implemented method of claim 1, wherein the age group of the first user comprises eighteen (18) years and younger.

6. The computer-implemented method of claim 5, wherein the frequency of the sound wave comprises substantially twenty (20) kilo Hertz.

7. The computer-implemented method of claim 6 further comprising:
determining an age-group of a second user.

8. The computer-implemented method of claim 7, wherein the age group of the second user comprises forty (40) years and older.

9. The computer-implemented method of claim 8, wherein the sound wave comprises a frequency that cannot be heard by the second user.

10. A auditory jamming system configured to jam audio content; said system comprising:
an audio input device configured to receive ambient sounds;
a user analysis system configured to:
determine an age group of a user;
identify a media content available to the user; and
determine whether the user has permission to listen to the media content; and
an audio output management system configured to jam the media content with a sound wave at a frequency that can be heard by the user when the user does not have permission to listen to the media content.

11. The auditory jamming system of claim 10, wherein the user analysis system is configured to implement a voice age-recognition algorithm to determine the age group of the user.

12. The auditory jamming system of claim 11, wherein the age group of the user comprises eighteen (18) years and younger.

13. The auditory jamming system of claim 12, wherein the frequency of the sound wave comprises substantially twenty (20) kilo Hertz.

14. The auditory jamming system of claim 13, wherein user analysis system includes a biosignal sensor.

15. The auditory jamming system of claim 14, wherein the biosignal sensor senses a user biosignal that indicates the age group of the user.

16. The auditory jamming system of claim 15, wherein the biosignal sensor comprises a video camera and an application that determines a user pulse rate from a user image.

17. The auditory jamming system of claim 15, wherein an amplitude of the sound wave is increased until the user biosignal achieves a specified threshold.

18. A method comprising:
receiving a first user's voice stream with a microphone;
receiving a second user's voice stream;
identifying a first user;
identifying a second user;
obtaining an ambient sound stream;
determining whether the first user has permission to listen to the ambient sound stream; and
causing a high-frequency sound wave to be emitted by a media player, wherein the high-frequency sound wave can be heard by the first user based on a first user's age group and not by the second user based on the second-user's age group when the first user does not have permission to listen to the ambient sound stream.

19. The method of claim 18, wherein the first user and the second user are proximate to the media player providing the ambient sound stream.

20. The method of claim 19,
wherein the first user is identified based on a speaker recognition analysis of the first user's voice stream, and
wherein the second user is identified based on a speaker recognition analysis of the second user's voice stream.
